(19) United States
(12) Patent Application Publication
(10) Pub. No.: US 2023/0129990 A1
(43) Pub. Date: Apr. 27, 2023

(54) OMNI-BEARING INTELLIGENT NURSING SYSTEM AND METHOD FOR HIGH-INFECTIOUS ISOLATION WARD

(71) Applicant: SHANDONG UNIVERSITY, Jinan, Shandong (CN)

(72) Inventors: Zhi LIU, Jinan (CN); Yankun CAO, Jinan (CN)

(73) Assignee: SHANDONG UNIVERSITY, Jinan, Shandong (CN)

(21) Appl. No.: 17/910,466

(22) PCT Filed: Jul. 16, 2021
(86) PCT No.: PCT/CN2021/106859

§ 371 Date: Sep. 9, 2022

(30) Foreign Application Priority Data
Dec. 31, 2020 (CN) 202011641559.4

(51) Int. Cl. B25J 11/00; G05D 1/02; B25J 9/16; B25J 19/02

(52) U.S. Cl. CPC B25J 11/009; G05D 1/0246; B25J 9/163; B25J 19/02

(57) ABSTRACT

An omni-bearing intelligent nursing system and method for a high-infectious isolation ward, including: a nursing robot, including a robot body and a controller; a plurality of collectors, arranged in the isolation ward and used for detecting the physiological index of the user and transmitting the physiological index to a remote control system; a communication network, in a star topology structure and including a plurality of communication modules, and configured to realize the communication of each the nursing robot, the collector and the remote control system; and the remote control system, receiving the information of the collector, performing feature extraction on the collect multi-element physiological signals, combining the basic information of the user, perform learning by a decision tree model, dynamically adjusting the corresponding nursing level, and sending an instruction to the corresponding nursing robot.

### CROSS-REFERENCES TO RELATED APPLICATIONS

This application claims priority benefits to Chinese Patent Application No. 202011641559.4, filed 31 Dec. 2020, the contents of which are incorporated herein by reference.

### TECHNICAL FIELD

The invention belongs to the field of artificial intelligence pattern recognition and relates to an omni-bearing intelligent nursing system and method for a high-infectious isolation ward.

### BACKGROUND

Information of the related art part is merely disclosed to increase the understanding of the overall background of the present invention but is not necessarily regarded as acknowledging or suggesting, in any form, that the information constitutes the prior art known to a person of ordinary skill in the art.

Infectious diseases can be transmitted by direct contact with infected individuals, body fluids or excretions of infected persons, objects contaminated by infected persons, or through air transmission, water transmission, food transmission, contact transmission, soil transmission, vertical transmission (mother-to-child transmission), etc. Especially pulmonary infectious diseases, which are transmitted by the respiratory tract through air and droplets, have the typical characteristics of strong infectivity and fast transmission speed, which usually cause cluster outbreaks in hospitals, schools, public transport systems, and other places, resulting in a sharp increase in the number of patients and serious sudden public health events.

The diagnosis of a large number of suspected patients and the monitoring and rehabilitation process of confirmed patients need professional and complete isolation ward and medical nursing workers of a certain scale. How to effectively protect the medical workers in the close contact process with suspected and confirmed patients, reduce the hidden danger of infection, protect the safety of medical workers and avoid increasing the burden of medical resources in an emergency period are practical problems to be further solved in the field of infectious disease nursing. In the process of infectious disease nursing, the traditional protection of medical workers is mainly wearing masks, medical goggles, and special isolation protective clothing, and the nursing process is carried out following relevant infectious disease prevention and control regulations, which still have some practical difficulties that are difficult to overcome. First of all, the cleaning, disinfection, and replacement of protective equipment need to consume a large number of social resources, which will aggravate the shortage of materials during the critical period of fighting epidemic diseases and require the nationwide allocation of medical materials. Secondly, the protection process is complicated, and the unknown of new communicable diseases and the improper operation caused by uncontrollable factors will cause infection accidents among medical workers to varying degrees.

### SUMMARY

To solve the problems, the invention provides an omni-bearing intelligent nursing system and method for a high-infectious isolation ward, according to which a comprehensive nursing robot architecture is provided, which can autonomously or receive remote instructions to complete tasks such as drug delivery, diagnostic reagent taking and delivering, injection, etc., monitor the condition of the patient in real-time, adjust the nursing level and make intelligent decisions without close contact between medical workers and patients with infectious diseases.

According to some embodiments, the present disclosure uses the following technical solutions:

an omni-bearing intelligent nursing system for a high-infectious isolation ward, which comprises a remote control system, a communication network, a plurality of collectors, and a nursing robot, wherein:

the nursing robot comprises a robot body and a controller, wherein the controller controls a walking mechanism and a mechanical arm of the robot body to act according to a received remote control instruction;
the collector is arranged in an isolation ward and is used for detecting the physiological index of the user and transmitting the physiological index to the remote control system;

the communication network is in a star topology structure and comprises a plurality of communication modules, and is configured to realize the communication of each the nursing robot, the collector, and the remote control system; and the remote control system receives the information of the collector, performs feature extraction on the collected multi-element physiological signals, combines the basic information of the user, performs learning by a decision tree model, dynamically adjusts the corresponding nursing level, and sends an instruction to the corresponding nursing robot.

As an optional embodiment, the robot body is provided with a camera, and the controller is configured to receive data collected by the camera, complete real-time object video detection according to a target detection algorithm, and generate a corresponding instruction to the walking mechanism to realize automatic driving.

As an optional embodiment, a plurality of infrared sensors are arranged around the walking mechanism of the robot body to sense surrounding objects, and the controller receives data from the infrared sensors and controls the walking mechanism to change the route in time when encountering an obstacle.

As an optional embodiment, a mechanical palm is arranged on the mechanical arm, and a pressure sensor and an infrared sensor are arranged on the mechanical palm.

As an optional embodiment, the robot body is provided with storage space for storing nursing materials.

As an optional embodiment, the communication network takes the remote control system as the center, a communication module is arranged in different positions of the isolation ward and each nursing robot, and a backup link is established between different nursing robots, when information transmission between a certain nursing robot and the remote control system is not smooth, the backup link is started, and interaction is conducted with the remote control system through another nursing robot.

A working method based on the system comprises the following steps:

acquiring a physiological index containing multi-element physiological signals of each user in an isolation ward by using a collector;

carrying out feature extraction on the collected multi-element physiological signals, combining the basic information of the user, learning by using a decision tree model, adjusting a corresponding nursing level, and sending an indication of the corresponding nursing level to a certain nursing robot; and

the nursing robot moves to a corresponding position in the isolation ward according to the received indication and provides corresponding nursing materials and nursing actions for the user.

As an optional embodiment, the remote control system uses the existing medical data set as the data basis for training the decision tree model, searches for an optimal node and a branching method according to different user information, and determines the corresponding nursing level by using the impurity index as the basis for measuring the performance of the decision tree.

As an optional embodiment, the remote control system extracts features of mean value, standard deviation, low-frequency power, high-frequency power, and moving standard deviation according to the collected information of heart rate, pulse, and blood pressure of the patient, obtains a real-time nursing level adjustment scheme in combination with the information of users' age, gender, illness time and disease progression stage, and feeds back the real-time nursing level adjustment scheme to the nursing robot in the isolation ward to complete the nursing task.

As an optional embodiment, the controller uses a YOLO algorithm to control the nursing robot to automatically seek a task user target and drive to the execution area.

Specifically, the target detection is modeled as a regression problem for processing, and an end-to-end network structure is adopted to complete the process from a camera image input to an object position and category output, the YOLO network is based on a GoogLeNet network structure, and an Inception Module is replaced by a convolution layer to complete a cross-channel information integration; the convolution layer is used to extract features, and the full connection layer is used to predict the probability and position of objects in the scene to guide the driving route.

As an optional embodiment, the controller optimizes the actions of the mechanical arm by using a reinforcement learning algorithm, and the reinforcement learning is implemented by employing a strategy iteration, given an action execution strategy at first, a value function of the strategy is obtained by using an iterative Bellman equation, and then the strategy is updated by the value function, and the value function is recalculated after adjustment according to the evaluation, and the cycle is continued until the strategy converges to an optimal value function and strategy.

Compared with the prior art, the invention has the following beneficial effects:

The present disclosure provides a no-medical workers infectious disease isolation ward. Starting from the three basic ways of prevention and control of infectious disease, the comprehensive nursing robot on-site nursing and professional doctor's remote guidance are adopted to realize the complete shielding and blocking of transmission route between infected individuals and healthy personnel on the premise of completing nursing work, which effectively guarantees the safety of medical personnel. The nursing robot completes self-cleaning using ultraviolet irradiation or disinfectant spraying, etc., to avoid germ adhesion, and meanwhile, the robot is an abiotic individual and cannot become an intermediate host of germs, so cross-infection caused by contact with different patients in the nursing process is effectively avoided.

According to the present disclosure, the nursing robot is used for conveying materials (such as medicines, food, etc.) instead of personnel, and meanwhile, a multi-degree-of-freedom mechanical arm and a mechanical palm can be used for carrying out operations such as venipuncture, etc. At the same time, the controller of the robot uses a reinforcement learning algorithm to make the robot arm complete self-lifting, self-evolution, and more standard action in the process of repeated fine nursing operation through the cyclic iteration of trial, evaluation, feedback, improvement and retry.

According to the present disclosure, the nursing robots with different numbers can be equipped according to the nursing quantity demand of the isolation ward, to form an intelligent nursing team. The information exchange of the team adopts a star topology structure with the remote control platform as the center, which has the characteristics of high reliability and simple fault isolation. At the same time, a backup link can be established between different robots, when the information transmission between a certain robot and the central control platform is not smooth, the backup link can be started, and the other nursing robot interacts with the control center so that the nursing robot has good disaster tolerance capability.

According to the present disclosure, a regression-based deep learning target detection YOLO algorithm is adopted, and the categories and positions of different targets can be determined only by using one convolutional neural network (CNN). Object detection is modeled as a regression problem, unlike other deep learning-based sliding window combined classifier target detection algorithms, the detection process only contains a neural network to optimize detection performance in an end-to-end manner and achieve a faster object detection rate. In the training process, more abstract features can be learned, which improves the recognition ability of specific targets in the complex scene of the isolation ward.

### BRIEF DESCRIPTION OF THE DRAWINGS

The accompanying drawings constituting a part of the present invention are used to provide a further understanding of the present invention. The exemplary examples of the present invention and descriptions thereof are used to explain the present invention and do not constitute an improper limitation of the present invention.

FIG. 1 is an application scenario diagram of a comprehensive nursing intelligent robot;

FIG. 2 is a flow chart of task automation management of the comprehensive nursing intelligent robot;

FIG. 3 is an application scenario diagram of a no-medical workers isolation ward;

FIG. 4 is a mechanical structure diagram of the comprehensive nursing intelligent robot;

FIG. 5 is a schematic diagram of intelligent decision-making at the nursing level of the comprehensive nursing intelligent robot;

FIG. 6 is a structure diagram of an intelligent ward information interaction network;

FIG. 7 is a flow chart of automated execution of care actions;

FIG. 8 is a schematic diagram of a nursing action self-promotion algorithm based on reinforcement learning;

FIG. 9 is a structural frame diagram of an intelligent cruise system based on the YOLO algorithm;

FIG. 10 is a schematic diagram of control software design based on object-oriented; and

FIG. 11 is a flow chart of an algorithm of a nursing-level self-decision system based on ensemble learning.

### DETAILED DESCRIPTION

The present disclosure is further described below in conjunction with the accompanying drawings and embodiments.

It should be pointed out that the following detailed descriptions are all illustrative and are intended to provide further descriptions of the present invention. Unless otherwise specified, all technical and scientific terms used in the present invention have the same meanings as those usually understood by a person of ordinary skill in the art to which the present invention belongs.

It should be noted that the terms used herein are merely used for describing specific implementations, and are not intended to limit exemplary implementations of the present disclosure. As used herein, the singular form is also intended to include the plural form unless the context dictates otherwise. In addition, it should further be understood that the terms “comprise” and/or “include” used in this specification indicate that there are features, steps, operations, devices, components, and/or combinations thereof.

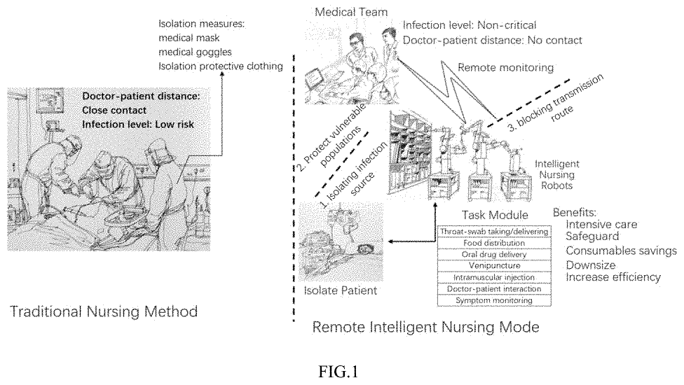

As shown in FIG. 1, in the traditional nursing mode, during the whole process from suspected diagnosis to treatment and rehabilitation of patients with infectious diseases, medical workers are required to participate in different links such as injection, delivery of diagnostic reagents, and drug distribution, and close contact is inevitable. Even if measures such as wearing medical masks, goggles, and isolation protective clothing are taken, the risk of infection of medical personnel cannot be completely avoided, and there is a considerable degree of unpreventable risk factors. In the present embodiment, the remote whole-course monitor of diagnosis and treatment is realized based on the intelligent robot, a patient is in a no-medical workers isolation ward, and an infection source is shielded firstly; the robot can complete a series of tasks such as venipuncture, doctor-patient interaction, symptom monitoring and so on only by the doctor giving instructions through the wireless channel in the control room, effectively protecting the susceptible population; at the same time, it completely avoids different contact links between medical workers and patients in the traditional nursing process, completely cuts off the transmission route, comprehensively guarantees the safety of medical workers, and avoids the spread of epidemic situation caused by doctor-patient contact.

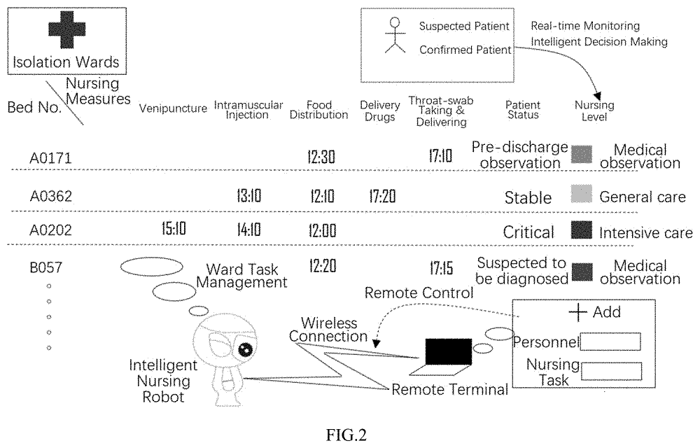

As shown in FIG. 2, an omni-bearing intelligent nursing system for a high-infectious isolation ward comprises a remote control system, a communication network, a plurality of collectors, and a nursing robot, wherein:

the nursing robot comprises a robot body and a controller, wherein, the controller controls a walking mechanism and a mechanical arm of the robot body to act according to a received remote control instruction;

the collector is arranged in the isolation ward and is used for detecting the physiological index of the user and transmitting the physiological index to the remote control system;

the communication network is in a star topology structure and comprises a plurality of communication modules, and is configured to realize the communication of each nursing robot, the collector, and the remote control system; and the remote control system receives the information of the collector, performs feature extraction on the collected multi-element physiological signals, combines the basic information of the user, performs learning by a decision tree model, dynamically adjusts the corresponding nursing level, and sends an instruction to the corresponding nursing robot.

Firstly, the nursing robot adopts a lithium battery to supply power for the robot, and the advantages of high energy density, large capacity, no memory, etc., are utilized so that the nursing robot can be rapidly charged on a 220V household power supply, and satisfactory effects can be achieved in aspects of high reliability, long-distance endurance, etc.

In a whole ward intelligent management and control strategy, the software architecture of an intelligent control program is complete by adopting a mode of bin data and behaviors into a whole based on an object-oriented strategy, as shown in FIG. 2, patients are regarded as a group of object members with common attributes, the object members have the attributes of defining object states such as age, gender, nursing level, disease condition, etc., and nursing links such as reagent diagnosis, injection, medication, etc., need to be executed at a specific time point, these specific operations to be performed are methods; defining all patients as a class, and constructing objects based on the class definition by instantiation, i.e., individual patients with different attributes and requiring different care measures to be performed.

Using a circular queue method to complete comprehensive management of patient care affairs in the whole ward, and implementing the affairs stored in the memory space one by one according to the time sequence of FIFO (first-in, first-out), making full use of the storage space and avoiding the occurrence of “false overflow” phenomenon. The medical workers use the remote control platform to add patients and targeted diagnosis and treatment measures to the intelligent system. The instructions are wirelessly transmitted based on WiFi, 5G, Bluetooth, Zigbee, and other different Internet of Things Hub standards. The intelligent nursing robot located in the isolation ward begins to perform nursing operations; meanwhile, the robot can also send the monitored video-based patient dynamic information to the remote monitoring platform by wireless transmission, to complete the doctor's visit and doctor-patient interaction.

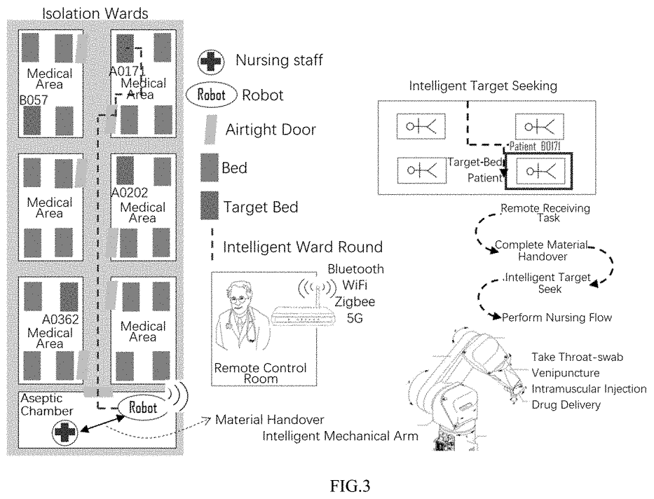

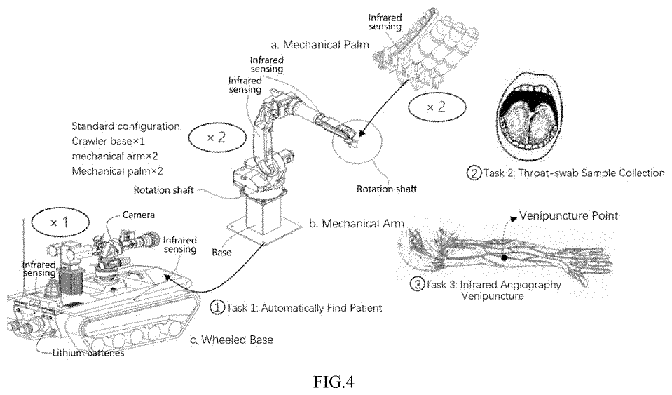

As shown in FIG. 3, after receiving the task through the command center, the intelligent nursing robot completes the handover of medical materials with the specialized medical workers in the sterile warehouse and automatically plans the route based on the bed coordinates of the target patient in the task queue. As shown in FIG. 4, real-time object video detection is completed by using the camera mounted on a wheeled base in combination with the relevant target detection algorithm to realize automatic driving. The wheeled base is driven by lithium batteries, and a multi-drive crawler structure has the characteristics of good stability and strong power, can effectively overcome the damage of medical articles caused by bumping during walking compared with a leg-shaped mechanical structure, and can adapt to special road conditions such as steps, doorsills, etc., in a ward. The infrared sensor mounted on the side of the wheeled base is used for sensing surrounding objects, and the route is changed in time to avoid collision when encountering obstacles.

In the present embodiment, a standard six-degree-of-freedom mechanical arm is mounted on the wheeled base, a mechanical palm is mounted at the tail end of the arm; the arm and the palm are powered by lithium batteries, and rely on motors and solenoids as a transmission device. The mechanical palm is equipped with a built-in pressure sensor, which can transmit the force to the central processing chip in real-time when grasping or moving objects, which can effectively prevent cotton swabs from falling or bagged medical reagents from being squeezed and broken. Taking the nursing of patients infected with the COVID-19 as an example, after the wheeled base travels to the task area, the mechanical arm will be started, and the complex operation of throat swab sampling can be completed in combination with the palm at the end. The infrared sensors mounted on the arm and palm are used to perform thermal infrared vascular imaging on the human arm to determine the venous structure to complete the puncture task. At the same time, the reinforcement learning module built in the robot chip is used to continuously optimize the action according to the feedback during the execution of repeated throat swab sampling, venipuncture, and other tasks, so that the nursing ability can be continuously improved.

The robot can be an existing nursing robot.

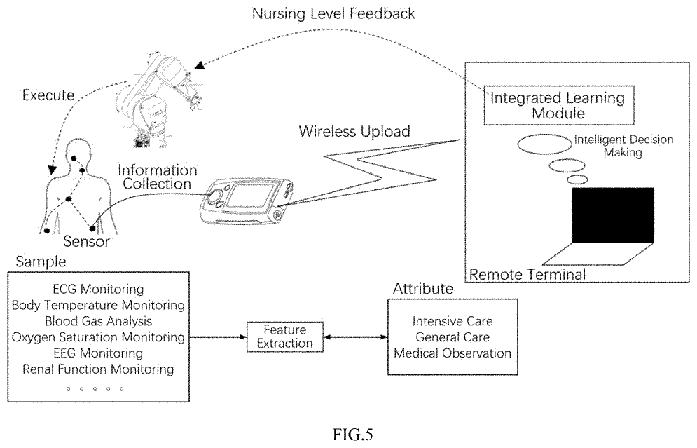

As shown in FIG. 5, physiological signals such as blood pressure, pulse, body temperature, and oxygen saturation in the full-time domain are obtained by sensing devices worn on multiple parts of the patient and sent to the remote terminal through wireless transmission. The intelligent algorithm module based on integrated learning in the terminal will judge the nursing level to be taken according to the multi-modal physiological information in combination with the gender, age, and other characteristics of the patient, and feedback the command to the comprehensive nursing robot, then the robot will automatically adjust different nursing level modes according to the decision.

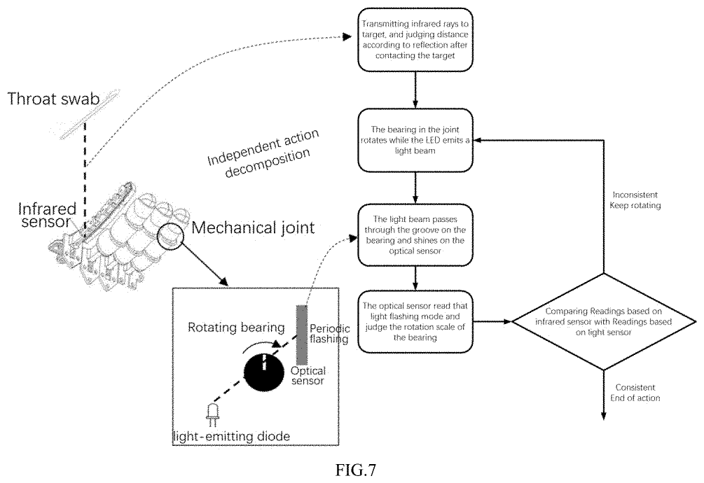

In the specific implementation, when the mechanical joint movement is controlled, the joint movement is the basic unit for the intelligent manipulator (i.e. the mechanical arm and the mechanical palm) to complete the complex nursing task, determine the target distance, and accurately judge whether the joint rotation scale meets the task completion requirement is the standard process for realizing the joint intellectualization. As shown in FIG. 7, it is an intelligent control flow of joint rotation with independent action. The infrared sensor on the side of the palm emits infrared beams to the target, and the distance is judged according to the reflected light. A light-emitting diode, a rotating bear, and an optical sensor are arranged in that joint, after the bearing starts to rotate, light rays emit by the light-emitting diode penetrate through a groove on the bearing and irradiate on the optical sensor, the optical sensor can read a periodic light flashing mode along with the rotation of the bearing, the rotating scale of the bearing is judged according to the periodic light flashing mode, the distance value obtained by the optical sensor is compared with the distance judged by the infrared sensor if the distance value obtained by the optical sensor is consistent with the distance judged by the infrared sensor, the rotation is stopped to finish an independent action; if not, continue to rotate until the target size is reached. The rotation of mechanical joints at different parts can be combined into a series of complex actions. Taking the nursing of patients with the COVID-19 as an example, the manipulator can carry out the nursing process of grasping throat swabs to sample and recover them in the oral cavity and throat.

In the aspect of thermal infrared imaging of vein structure, as shown in FIG. 4, the thermal infrared imaging device mounted outside the mechanical arm obtains the venous blood vessel imaging of the human arm, and sends the thermal imaging picture to the central processing unit of the nursing robot, selects the appropriate needle entry point according to the picture, and performs venipuncture operation according to the determined puncture point after the mechanical arm completes the action of grasping the injection needle. Under manual conditions, the completion of throat swab sampling, venipuncture, and other operations not only requires professional training but also requires a certain period of clinical practice. With the help of a reinforcement learning algorithm, the technical indicators such as oral wiping site of throat swab, puncture angle of venous needle, puncture depth, and so on can be continuously corrected during the repeated operation of the mechanical arm, to strengthen the reasonable standardization of nursing actions.

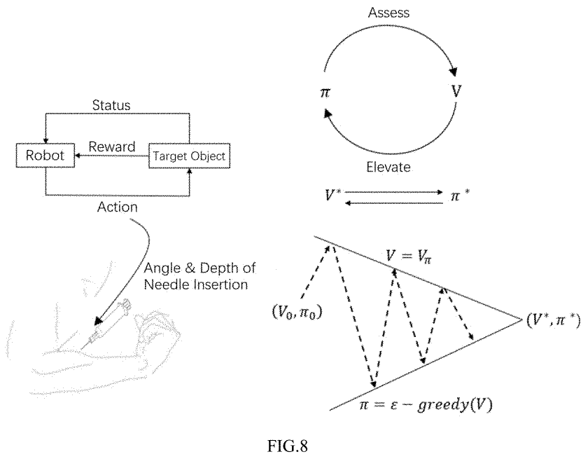

In the aspect of self-promotion of nursing action based on reinforcement learning, the robot arm can continuously interact with the external environment during the task execution process by using a reinforcement learning algorithm, obtain the feedback signal of the task object (the cared person), acquire the mapping relationship from the object state to the action behavior, and optimize the action. As shown in FIG. 8, taking venipuncture as an example, the robot can continuously improve the action scheme such as puncture angle and depth to adapt to the task object in the nursing process of action, evaluation, improvement, and re-action. Reinforcement learning is implemented by strategy iteration. Firstly, an action execution strategy is given, and the value function of the strategy is obtained by the iterative Bellman equation, and then the strategy is updated by the value function. A ε-greedy strategy as shown in FIG. 8 represents the depth of venipuncture, refers to the behavior that can obtain the maximum satisfaction under the probability choice of ε, randomly selects an action mode with a probability of 1−ε. After adjustment according to the evaluation, the value function is recalculated and the loop is repeated until the strategy converges. The iterative process finally converges to an optimal value function V*(s) and a strategy π*, which indicates that that action strategy can meet the requirements of the clinical operation specification.

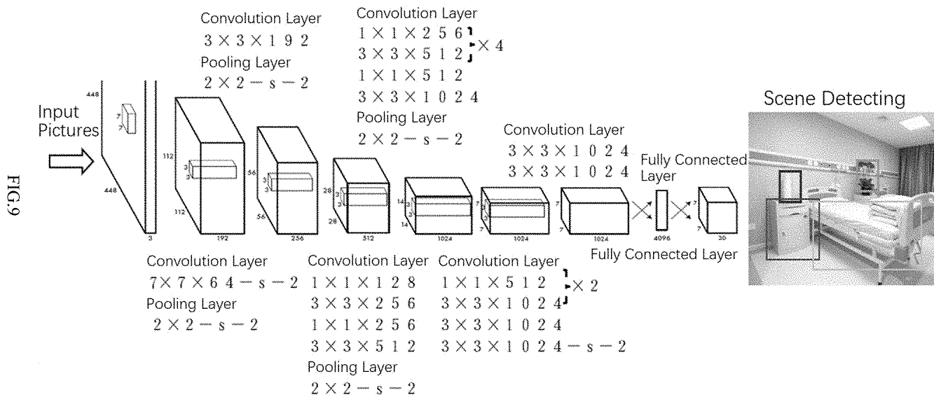

In the aspect of automatic searching of nursing objects based on target detection, the YOLO algorithm is used to control the nursing robot to automatically search for the target of the task patient, and the real-time decision is made through the top camera device in the process of driving to the execution area, to ensure that no collision is caused by contact with other pedestrians or objects and other obstacles. First, the target detection is modeled as a regression problem, and an end-to-end network structure is adopted to complete the process from the input of the camera image to the output of the object position and category. The YOLO network is based on the GoogLeNet network structure, as shown in FIG. 9. The Inception module is replaced by the convolution layer 1×1+3×3 to complete cross-channel information integration. The convolution layer is used to extract features, and the full connection layer is used to predict the probability and position of objects in the scene, to guide the driving route. Different from the target recognition mode of sliding window and region detection, the strategy of taking full images as scene information further reduces the detection error rate.

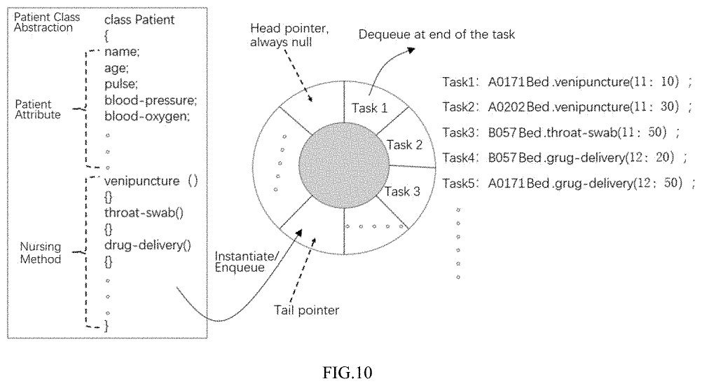

In the design of nursing task control flow based on an object-oriented method, an object-oriented software design method can complete the framework of the program by using the model organization form close to the real world. As shown in FIG. 10, the present embodiment adopts the strategy of simplifying the complexity, generalizes the specific nursing objects (patients), extracts and describes the common properties of such objects, and constructs the patient class. The method specifically comprises two steps, namely data abstraction and behavior abstraction, wherein the basic information such as age, gender, pulse, blood pressure, and oxygen saturation shared by patients are defined as the attributes of classes, and the data abstraction is completed; the specific nursing operations that the intelligent robot needs to make to the patients at different times, such as drug delivery, throat swab sampling, venipuncture, etc., are defined as methods, and the behavior abstraction is completed. The patient class is instantiated as a specific patient object, and the intelligent robot evaluates the patient condition based on the patient attribute and carries out nursing work on the patient based on the behavior abstracted by the patient object. The management of nursing tasks is carried out by adopting a circular queue structure, circular logical space is formed by utilizing a continuous physical storage structure, the first nursing task of a team is discharged when the first nursing task is finished, and a new nursing task is added into the queue from the tail of the team, so that storage resources are effectively saved, and the occurrence of false overflow is prevented. The nursing robot reads the task units arranged in time sequence in the circular queue in sequence, executes nursing modules such as medicine delivery, injection, etc., and can orderly complete one-to-many nursing work in a duty cycle.

In the aspect of decision-making at the nursing level based on ensemble learning, because infectious diseases generally have the characteristics of rapid change and rapid progress, under the condition of artificial nursing, doctors should not only be able to make a correct judgment on the condition of patients according to an all-round situation but also have strong ability to deal with the situation on occasion and considerable clinical experience. During the epidemic period, due to the rapid increase in the number of patients, there is a shortage of nursing doctors with rich clinical experience, and improper diagnosis and evaluation will also lead to excessive treatment or delay of treatment. The existing automatic medical monitoring equipment, only provides several physiological data of the patient to the nursing physician, and then evaluates the condition manually, which still depends on the clinical experience of the physician, or mechanically inputs the data into a mathematical formula established in a model-driven manner for rough evaluation, which completely ignores the existence of individual differences of the patient.

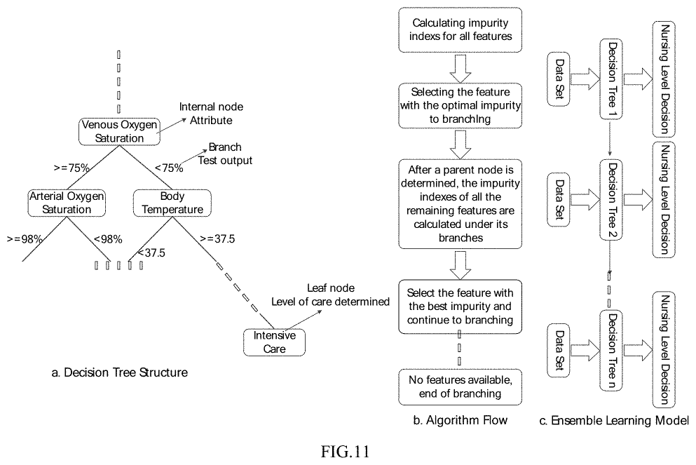

The decision tree is a tree structure, as shown in FIG. 11a, each internal node represents a test on an attribute, such as whether the arterial oxygen saturation is lower than 98%, branches represent test outputs, and leaf nodes at the end of the path represent evaluation conclusions. According to the present embodiment, the related medical data set is used, which also is as the basis that can be reasonably expanded and perfected, as the data basis for training the decision tree model, the optimal node and the branch method are searched according to different patient information, and the impurity index is used as the basis for measuring the performance of the decision tree. Each node in the decision tree has an impurity, and the impurity of child nodes is lower than that of the parent node, that is, the parent node attributes in the care level discrimination reflected in the significance of higher than the child nodes. Using the Gini coefficient to determine the impurity:

$$Ginit ( t ) = 1 - {\sum }_{i = 0}^{c - 1} {p ( i \vert t )}^{2} \qquad ( 1 )$$

Wherein, t represent a given node, i represent the level of care grade, p(i|t) represent the sample size to achieve the care level i under the condition of the attribute t. As shown in FIG. 11b, the algorithm flow for constructing a single decision tree is shown. When all the features are used up, the overall impurity is optimal, that is, the optimal diagnosis decision scheme is obtained, and the cycle ends. As shown in FIG. 11c, the present embodiment adopts the ensemble learning strategy and performs the final prediction by combining multiple weak learners (decision trees) through the gradient boosting machine (GBM). The nodes in each decision tree adopt different function subsets (ID3, C4.5, C5.0, etc.) to select the optimal splitting scheme, and the constructed different decision trees can capture different information from the data. Each newly constructed decision tree will pay attention to the diagnosis errors made by the previous decision tree in the way of increasing the weight, so the performance is gradually optimized to realize the effect of gradient improvement. As shown in FIG. 5, the collected information such as heart rate, pulse, and blood pressure of the patient is used to extract the features such as mean value, standard deviation, low-frequency power, high-frequency power and moving standard deviation, and the individual information such as age, gender, disease duration and disease progression stage of the patient is combined. The integrated learning module in the remote platform is input to obtain a real-time nursing level adjustment scheme, and the real-time nursing level adjustment scheme is fed back to the robot in the isolation ward to guide the completion of nursing tasks.

The embodiments described above have the following advantages:

(1) The no-medical workers infectious disease isolation ward. Starting from the three basic ways of infectious disease prevention and control the comprehensive nursing robot on-site nursing and professional doctor's remote guidance are adopted to realize the complete shielding and blocking of transmission route between infected individuals and healthy personnel on the premise of completing nursing work, which effectively guarantees the safety of medical personnel. The strategy based on protective clothing isolation in the traditional nursing process is upgraded to man-machine cooperative non-dangerous nursing, which effectively avoids the real problem that the shortage of medical resources is further aggravated due to the infection of medical personnel in the nursing process, saves a large amount of protective and disinfection consumables, and guarantees the development of nursing work under low-cost conditions from both manpower and material resources. As shown in FIG. 3, one doctor in the remote monitoring room completes the condition monitoring and nursing task assignment, one nurse in the sterile warehouse completes the delivery of medical materials, and a plurality of intelligent nursing robots in the ward completes the specific nursing task, that is, the nursing of more than 20 beds in the whole ward can be realized in one duty cycle. The traditional nursing method requires a large scale of medical workers, and a critically ill patient usually needs more than one nursing worker to care for at the same time. The management mode of no-medical workers isolation ward has realized the change of nursing method from many-to-one to one-to-many between doctors and patients. Compared with the remote deployment of personnel, it is a more ideal localized emergency response method against the background of the sudden growth of patients with epidemic outbreaks, effectively alleviating the shortage of medical workers. The nurse robot finishes self-cleaning by ultraviolet irradiation or disinfectant spray and that like to avoid the adhesion of germs, and simultaneously, the robot is an abiotic individual and cannot become an intermediate host of the germs, and effectively avoid cross-infection caused by contact with different patients in the nursing process.

(2) The object-oriented software architecture and task management strategy of the circular queue. As shown in FIG. 2, the nursing robot carries out the overall arrangement of nursing work for multiple patients through task management software. The management software is embedded into the built-in chip of the robot in an embedded way. The client is mounted in the remote data terminal, which can adapt to various operating systems such as Windows, Lunix, Unix, Android, Apple, etc. One computer and one CD can complete the construction of a remote nursing command center. The simple and convenient workflow fully adapts to the urgent time under the emergency epidemic situation, and the personnel, the characteristics of the lack of supplies. The object-oriented development model can effectively improve the programming efficiency, not only can use a fixed management program mode, but also can design a targeted intelligent nursing team comprehensive management platform applied to a special type of isolation ward scene in a short period after the outbreak of the epidemic, and meanwhile, the program has the characteristics of good reusability, flexibility, expandability, etc. The management program adopts a circular queue structure to carry out the overall arrangement of nursing affairs, and based on ensuring the orderly development of tasks, transaction congestion is effectively avoided, and the utilization rate of the storage space is improved.

(3) The intelligent manipulator can complete complex nursing tasks. Taking the nursing of patients infected with new coronavirus as an example, the completion of throat swab sampling is a necessary step for the diagnosis of patients. During the process, a large number of virus-carrying droplets can be produced by the collected persons through mouth opening, coughing, vomiting, and other actions, resulting in the risk of infection among medical workers. Respiratory infectious diseases have explosive characteristics. In the early stage of the epidemic situation, a large number of works of personnel screening and detection led to a sharp increase in throat swab sampling tasks, resulting in inadequate protective measures. Meanwhile, due to the unknown infection mode of epidemic transmission route in the early stage, as well as the low protection level and low vigilance of medical personnel, the risk of infection among medical workers was further aggravated. According to the present invention, the related theory of mechanical mechanics and human engineering is combined with the target task of fine nurses, and the nursing robot can complete a series of complex nursing operations under the condition of no on-site participation of medical workers through intelligent algorithm control. As shown in FIG. 4, the mechanical palm has 12 degrees of freedom, can complete grasping, rotating, touching, pressing and other actions simultaneously judges the target distance by combining with the infrared sensor arranged on the outer side of the palm, can grab a cotton swab to extend into the throat of a patient for wiping action at a short distance, and puts the cotton swab into the recycling bin. Meanwhile, the surface of the palm is attached with a protective film made of a polymer carbon fiber material, which not only has the advantages of high-temperature resistance, Heavy isolation protective clothing needs to be worn for infectious disease nursing so that the difficulty of artificial venipuncture is increased; the side surface of the mechanical arm is provided with an infrared vascular imaging sensor so that the venous vascular structure of the forearm of a patient can be obtained, and the movement of a mechanical palm is guided; the invention implants a reinforcement learning algorithm into a control program, and leads the mechanical arm to complete self-lifting and self-evolution in the repeated fine nursing operation process through cyclic iteration of trial, evaluation, feedback, improvement, and re-trial so that the action is more standard and normative.

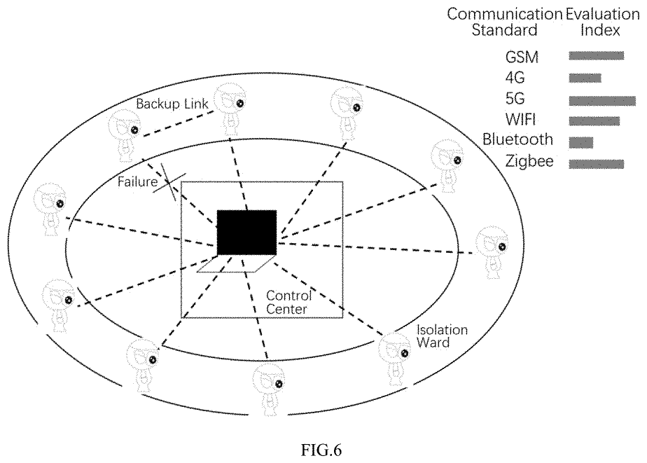

(4) Information exchange system based on star network structure. As shown in FIG. 6, according to the nursing volume demand of isolation wards, a different number of nursing robots can be equipped to form an intelligent nursing team. The information exchange of the team adopts a star topology structure with the remote control platform as the center, which has the characteristics of high reliability and simple fault isolation. At the same time, a backup link can be established between different robots, when the information transmission between a certain robot and the central control platform is not smooth, the backup link can be started, and the other nursing robot interacts with the control center so that the nursing robot has good disaster tolerance capability. Under certain circumstances, the isolation ward will gather people. For example, the shelter hospital can accommodate more than one thousand patients in a centralized manner. The information interaction between patients and the outside and real-time epidemic situation notification shall be carried out through a wireless network, which will lead to network resource shortage and information congestion. The information transmission of the intelligent robot nursing team adopts a multi-mode working mode, and the Gobi baseband chip of the United States is mounted, which does not occupy an independent frequency band to save frequency resources. It can use the existing 5G, WiFi, and other communication standards. On the basis, of a code division, multiple access technologies are combined to ensure that a plurality of team members can interact with a control center at the same time on the same frequency band, thereby further saving frequency band resources.

(5) Intelligent patient target positioning based on unmanned technology. The intelligent nursing robot can automatically drive to the task execution area through unmanned driving technology after determining the nursing goal and specific execution task, and completing the handover of medical materials with the nursing workers in the sterile room. A camera mounted above the wheeled base is combined with a real-time video object detection algorithm to complete target determination in a real scene. The traditional target detection algorithm adopts three basic steps of region selection, feature extraction, and classifier classification, and has the defects of high time complexity, lack of pertinence of region selection, low robustness of manual feature extraction, etc. The invention adopts a deep learning target detection YOLO algorithm based on a regression method and can determine the types and positions of different targets only by using a convolutional neural network (CNN). The object detection is modeled as a regression problem for processing, which is different from other target detection algorithms based on a sliding window combined with a classifier of deep learning, and the detection flow only comprises one neural network, so that the detection performance is optimized in an end-to-end model, and a faster object detection rate is obtained. More abstract characteristics can be learned in the training process, and the recognition capability of a specific target under the complex scene of an isolation ward is improved.

(6) The intelligent decision system of patient monitoring level based on multiple information. Graded nursing is according to the patient's condition of light, heavy, slow, or urgent to give different levels of care. The decision tree model based on data-driven can effectively explore the nonlinear relationship between data, and has been widely used in the field of clinical diagnosis and achieved good results. As shown in FIG. 5, a patient wears patches made of a high-sensitivity sensor at different parts, the physiological index such as body temperature, pulse, oxygen saturation, electro cardio, etc., can be acquired in real-time, and the information is transmitted to a remote platform through a wireless route, the multi-element physiological signals are input into a higher-recognition-accuracy integrated learn module constructed on that basis of a decision tree model in a platform through feature extraction and information such as age, gender, infectious disease type, disease stage, etc., of a patient; the module dynamically adjust the nursing level of the patient and sends an instruction to a nursing robot in an isolation ward; and the robot formulates a targeted nursing scheme according to different nursing levels so that the patient can obtain individualized real-time comprehensive rehabilitation treatment.

(7) Wide applicability. The combination of the non-medical isolation ward and the omnidirectional intelligent nursing robot can be used for centralized nursing of many high-infectious diseases, such as cholera, plague, new coronavirus, SARS, avian influenza, etc. In the military field, it can also be used for field rescue facing chemical and biological weapons attacks, which has wide applicability.

Those skilled in the art will appreciate that embodiments of the present disclosure may be provided as methods, systems, or computer program products. Therefore, the present disclosure may take the form of a full hardware embodiment, a full software embodiment, or an embodiment combining software and hardware aspects. Further, the present disclosure may take the form of a computer program product implemented on one or more computer-usable storage media (including but not limited to a disk memory, CD-ROM, optical memory, etc.) containing computer usable program codes.

The present disclosure is described with reference to flowchart illustrations and/or block diagrams of methods, apparatus (systems), and computer program products according to embodiments of that disclosure. it will be understood that each flow and/or block of the flowchart illustrations and/or block diagrams, and combinations of flows and/or blocks in the flowchart illustrations and/or block diagrams, can be implemented by computer program instructions. these computer program instructions may be provided to a processor of a general-purpose computer, special purpose computer, embedded processor, or other programmable data processing apparatus to produce a machine, such that the instructions, which execute via the processor of the computer or other programmable data processing apparatus, create means for implementing the functions specified in the flowchart flow or flows and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart flow or flows and/or block diagram block or blocks.

The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart flow or flows and/or block diagram block or blocks.

The foregoing descriptions are merely preferred embodiments of the present invention but are not intended to limit the present invention. A person skilled in the art may make various alterations and variations to the present invention. Any modification, equivalent replacement, or improvement made within the spirit and principle of the present invention shall fall within the protection scope of the present invention.

Although the specific embodiments of the invention are described above in combination with the accompanying drawings, it is not a limitation on the protection scope of the invention. Those skilled in the art should understand that based on the technical scheme of the invention, various modifications or deformations that can be made by those skilled in the art without creative labor are still within the protection scope of the invention.

1. An omni-bearing intelligent nursing system for a high-infectious isolation ward, comprising a remote control system, a communication network, a plurality of collectors, and a nursing robot, wherein:
the nursing robot comprises a robot body and a controller, wherein the controller controls a walking mechanism and a mechanical arm of the robot body to act according to a received remote control instruction;
the collectors are arranged in an isolation ward and are used for detecting the physiological index of the user and transmitting the physiological index to the remote control system;
the communication network is in a star topology structure and comprises a plurality of communication modules, and is configured to realize the communication of each the nursing robot, the collector, and the remote control system; and
the remote control system receives the information of the collector, performs feature extraction on the collected multi-element physiological signals, combines the basic information of the user, performs learning by a decision tree model, dynamically adjusts the corresponding nursing level, and sends an instruction to the corresponding nursing robot.

2. The omni-bearing intelligent nursing system according to claim 1, wherein: the robot body is provided with a camera, and the controller is configured to receive data collected by the camera, complete real-time object video detection according to a target detection algorithm, and generate a corresponding instruction to the walking mechanism to realize automatic driving.

3. The omni-bearing intelligent nursing system according to claim 1, wherein: a plurality of infrared sensors are arranged around the walking mechanism of the robot body to sense surrounding objects, and the controller receives data from the infrared sensors and controls the walking mechanism to change the route in time when encountering an obstacle.

4. The omni-bearing intelligent nursing system according to claim 1, wherein: a mechanical palm is arranged on the mechanical arm, and a pressure sensor and an infrared sensor are arranged on the mechanical palm.

5. The omni-bearing intelligent nursing system according to claim 1, wherein: the communication network takes the remote control system as a center, a communication module is arranged in different positions of the isolation ward and each nursing robot, and a backup link is established between different nursing robots when information transmission between a certain nursing robot and the remote control system is not smooth, the backup link is started, and interaction is conducted with the remote control system through another nursing robot.

6. A working method based on the omni-bearing intelligent nursing system according to claim 1, comprising:
acquiring a physiological index containing multi-element physiological signals of each user in an isolation ward by using a collector;
carrying out feature extraction on the collected multi-element physiological signals, combining the basic information of the user, learning by using a decision tree model, adjusting a corresponding nursing level, and sending an indication of the corresponding nursing level to a certain nursing robot; and
the nursing robot moves to a corresponding position in the isolation ward according to the received indication and provides corresponding nursing materials and nursing actions for the user.

7. The working method according to claim 6, wherein: the remote control system uses the existing medical data set as the data basis for training the decision tree model, searches for an optimal node and a branching method according to different user information, and determines the corresponding nursing level by using the impurity index as the basis for measuring the performance of the decision tree.

8. The working method according to claim 6, wherein: the remote control system extracts features of mean value, standard deviation, low-frequency power, high-frequency power, and moving standard deviation according to the collected information of heart rate, pulse, and blood pressure of the patient, obtains a real-time nursing level adjustment scheme in combination with the information of users' age, gender, illness time and disease progression stage, and feeds back the real-time nursing level adjustment scheme to the nursing robot in the isolation ward to complete the nursing task.

9. The working method according to claim 6, wherein: the controller uses a YOLO algorithm to control the nursing robot to automatically seek a task user target and drive to the execution area: the target detection is modeled as a regression problem for processing, and an end-to-end network structure is adopted to complete the process from a camera image input to an object position and category output, the YOLO network is based on a GoogLeNet network structure, and an Inception module is replaced by a convolution layer to complete a cross-channel information integration; the convolution layer is used to extract features, and the full connection layer is used to predict the probability and position of objects in the scene to guide the driving route.

10. The working method according to claim 6, wherein: the controller optimizes the actions of the mechanical arm by using a reinforcement learning algorithm, and the reinforcement learning is implemented by employing a strategy iteration, given an action execution strategy at first, a value function of the strategy is obtained by using an iterative Bellman equation, and then the strategy is updated by the value function, and the value function is recalculated after adjustment according to the evaluation, and the cycle is continued until the strategy converges to an optimal value function and strategy.
